(19) United States
(12) Patent Application Publication
(10) Pub. No.: US 2005/0196734 A1
(43) Pub. Date: Sep. 8, 2005

(54) Method for improving the administration of psychological examinations

(76) Inventor: Amir Poreh, Pepper Pike, OH (US)

Correspondence Address: DR. MARK FRIEDMAN LTD.;C/o Bill Polkinghorn, Discovery Dispatch, 9003 Florin Way, Upper Marlboro, MD, 20772, US

(21) Appl. No.: 10/859,215

(22) Filed: Jun. 3, 2004

Related U.S. Application Data
(60) Provisional application No. 60/550,099, filed on Mar. 4, 2004.

(51) Int. Cl. G09B 19/00

(52) U.S. Cl. 434/236

(57) ABSTRACT

A method of administering ecologically valid psychological examinations to an examinee by an examiner equipped with a computer, the method including: (a) visually presenting stimuli or instructions to the examiner on a display operationally connected to the computer; and (b) performing an action by the examiner either (i) reading out loud the stimuli or the instructions; or (ii) pressing an input device operationally connected to the computer thereby audibly playing the stimuli or the instructions to the examinee over a sound system operationally connected to the computer; wherein the examinee does not interact with the computer nor see the display.

### CROSS REFERENCE TO RELATED APPLICATIONS

This application claims the benefit from U.S. provisional application 60/550099 filed on Mar. 4, 2004 by the present inventor.

### FIELD AND BACKGROUND OF THE INVENTION

The present invention relates to the field of psychological evaluation and more specifically to a method for improving the administering of ecologically valid, multi-stage psychological examinations, and specifically to a method providing an auditory presentation of instructions, data, and stimuli to the examinee.

In the course of traditional psychological examinations, the examinee performs tasks in a ecologically valid manner, or a life-like manner; for instance using pencil and paper, responding verbally to questions, manually manipulating objects, or solving puzzles that require manual dexterity or graph-motor speed.

The scoring of examinees on a particular psychological examination is usually determined by comparing their performance with normative data that specify the mean performance of large groups of people on that examination. It is therefore required that all psychological examinations or tests should be conducted in a standardized, similar manner. Thus, the “Standards for Educational and Psychological Testing”², specifies that “ . . . test examiners should follow carefully the standardized procedures for administration and scoring specified by the test publisher”. Since research has demonstrated¹ that variations in the way instructions are given during tests could alter the responses of the examinee, it is obvious that instructions in a well conducted psychological test should be given in a clear manner exactly as specified in the test manual. Indeed, most tests manuals ask the examiner to read at each stage of the test the original instructions, which appear in the manual. In reality, however, as pointed out by Moon et al.⁶, such guidelines are not often followed, particularly in complicated multi stage tests and when such tests are administered by a technician or by inexperienced psychologists. Many experienced examiners rely on their memory and do not read the instructions that appear in the test manual during the test administration. In many cases examiners explain in a way they feel is preferred, without realizing that once they do not adhere to the original procedures and do not deliver the instructions exactly as specified in the manual, they reduce the reliability and validity of the test. In some tests, data and/or stimuli, such as a list of words are spoken to the examinee at a given pace. It is very difficult to precisely fulfill this requirement.

The complexity of the task of properly administering psychological tests is demonstrated by an instructional procedure for carrying out auditory verbal tests known as the Rey Auditory Verbal Learning Test⁵. This test is usually composed of nine (9) stages and at the start of each stage, the examiner orally conveys different instructions to the examinee. At the start of each of the first five (5) stages of this test, for example, the examiner tells the examinee that a list of 15 words (List A) will be read to him and that subsequently the examinee is expected to recall as many words as possible from the list. Next, the examiner reads the list loudly and clearly at a pace of one word per second with an interval of exactly one second between words. Then, the examiner asks the examinee to start recalling words from the list the examinee has just heard. The examiner is required to record the words recalled by the examinee, which keeps him quite busy. At the 6^{th} stage, a different list of words (LIST B) is read by the examiner and the examinee is asked to recall words from this new list. At the 7^{th} stage of the test, the examiner asks the examinee to recall as many words as possible from the original List A. The 8^{th} stage of the test is performed after an intermission of 30 minutes. At this stage the examinee is again asked to recall as many words as possible from List A. Usually, at the 9^{th} stage of the test the examiner reads to the examinee, one by one, in a predetermined order and pace, words from a list of 50 words, which includes the 30 words of List A and List B as well as 20 other specific words. The examinee is instructed at the beginning of this stage to identify the words that belong to List A using the words “yes and “no”.

In view of the complexity of carrying out such test procedures and the importance of their accurate presentation according to predetermined rules, the state licensing boards of New York, Oregon, North Carolina and Arkansas have recently prohibited technicians from administering psychological tests.³ Unfortunately, these requirements and regulations increase the cost of administering such tests. To reduce this cost, many complicated tests are not administered at all.

Various methods have been proposed for computer-based methods for insuring high standards for administering psychological tests. For example, U.S. Pat. Nos. 5,211,564, 5,218,535, 5,513,994, 5,565,316, 5,961,332, 6,030,226, 6,280,198, 6,491,525 and 6,565,359 are directed towards methods in which the examinee is undergoing the examination with the use of a computer. U.S. Pat. No. 6,491,525 discloses auditory presentation of material to the examinee. However, none of these prior art methods is adequate for psychological testing of cognitively impaired computer illiterate or technologically illiterate populations. Moreover, it has been observed⁴ that when common tasks (e.g memory tasks requiring recollection of words, stories; puzzles; manual dexterity tasks; and pencil and paper tasks) that appear in psychological examinations are performed on a graphical interface of computer-based systems, the examinations lack ecological validity. When examinations are not conducted in a traditional life-like manner, the results obtained may significantly differ from performing a task in a conventional manner. For this reason, one may not use normative data from conventional; ecologically valid tests for scoring fully computerized tests and preparation of new dedicated sets of norms and new different instructions for the latter tests is required, a rather expensive task.

U.S. Pat. No. 6,629,846 discloses a method of ecologically valid testing but does not provide a method for auditory presentation of instructions, data, and stimuli to the examinee.

Thus, there is a need for a method that provides a presentation of auditory instructions, data and stimuli in a standard and precise manner, and simultaneously maintains the reliability of ecologically valid psychological testing. Moreover, there is a need for a method that would make it possible for minimally trained technicians to reliably administer ecologically valid psychological tests.

### REFERENCE

1. Gary Groth-Marnat (1990). Handbook of Psychological Assessment. John Wiley & Sons, Inc.
2. Standards for Educational and Psychological Testing: American Educational Research Association, Released: February, 2000, standard 15.1, p. 83
3. Jennifer Daw Holloway (2003) Psychologists are making headway in getting the prohibition on the use of nondoctoral testing technicians reversed in some states. APA Monitor, Volume 34, No. 1, p. 26.
4. Sbordone, R. J. and Long, C. J. Ecological Validity of Neuropsychological Testing (1996) Delray Beach, Florida: GR Press/St. Lucie Press.
5. Spreen O. & Strauss E., (1998). A Compendium of Neuropsychological Tests. Oxford University Press, New York.
6. Moon, G. W., Blakey, W. A., Gorsuch, R. L., & Fantuzzo, J. W. (1991). Frequent WAIS-R administration errors. Professional Psychology Research and Practice, 22, 256-258.

### SUMMARY OF THE INVENTION

According to the teachings of the present invention, instructions and stimuli are presented to the examiner on a computer display. The examiner reads instructions from the display to the examinee and/or presents stimuli as presented on the display to the examinee. Alternatively, the examiner directs the computer, e.g. by pushing a button on a computer input device, to present prerecorded instructions and/or stimuli to the examinee using a sound system of the computer. Preferably, the examinee does not view the computer display. Preferably, the sound system includes earphones or a loudspeaker.

According to the present invention there is provided a method of administering ecologically valid psychological examinations to an examinee by an examiner equipped with a computer, the method including: (a) visually presenting stimuli or instructions to the examiner on a display operationally connected to the computer; and (b) performing an action by the examiner either (i) reading out loud the stimuli or the instructions; or (ii) pressing an input device operationally connected to the computer thereby audibly playing the stimuli or the instructions to the examinee over a sound system operationally connected to the computer; wherein the examinee does not interact with the computer nor see the display. Preferably the method further includes (c) responding by the examinee to the stimuli or the instructions with a physically manifested responses; and (d) recording by the examiner of the responses and the recording is performed by pressing a record button operationally connected to an input device of the computer, thereby storing records in computer memory. Preferably, the method, further includes (e) ending the psychological examination by the examiner by pressing an end button operationally connected to an input device of the computer; and (f) storing a record on a storage device operationally connected to the computer by pressing a store report button operationally connected to an input device of the computer.

According to the present invention there is provided a method of administering ecologically valid psychological examinations to an examinee, the method comprising the steps of: (a) providing a computer operated solely by an examiner; (b) visually presenting one or more stimuli or one or more instructions to the examiner on a display operationally connected to the computer; and (c) performing an action by the examiner either (i) reading out loud the stimuli or the instructions; and (ii) pressing an input device operationally connected to said computer thereby audibly playing said the stimuli or said the instructions to the examinee over a sound system operationally connected to the computer. Preferably, the computer is a desktop computer, a portable computer, a notebook computer, a personal digital assistant or a handheld computer.

### BRIEF DESCRIPTION OF THE DRAWINGS

The invention is herein described, by way of example only, with reference to the accompanying drawings, wherein:

FIG. 1 is a drawing of a psychological examination administered according to an embodiment of the present invention;

FIG. 2 is a flow chart of a process for psychological examination according to an embodiment of the present invention;

FIG. 3 is a drawing of a computer display during a psychological examination according to an embodiment of the present invention;

FIG. 4 is a drawing of a computer display during another psychological examination according to an embodiment of the present invention.

### DESCRIPTION OF THE PREFERRED EMBODIMENTS

The present invention is a method of administering psychological tests by presenting at the command of the examiner prerecorded instructions, and/or stimuli to examinees in the course of the tests using the sound system of a computer.

By way of introduction, the principal intention of the present invention is to provide a method for administering ecologically valid psychological examinations by minimally trained technicians or by technicians not fluent in the mother tongue of the examinee.

The principles and operation of a method of administering psychological tests by presenting at the command of the examiner prerecorded instructions to examinees using the sound system of a computer, according to the present invention, may be better understood with reference to the drawings and the accompanying description. The term “computer” as used herein refers to a programmable electronic machine that performs that assembles, stores, correlates, displays and/or processes information. A “computer” as used herein includes a desktop computer, a portable (laptop) computer, a notebook computer, personal digital assistant or handheld computer. The term “input device” refers to any device typically used to input to a computer, such as a keyboard, mouse, and/or touch screen. The term “button” as used herein refers to a means of generating a computer interrupt such as with a key on a keyboard, a button on a mouse, or a virtual button on a computer display or touch screen.

The terms “stimulus” and “instruction” are used herein interchangeably although the term “stimulus” is generally used in order to receive and record a response whereas the term “instruction” is generally used when recording a response is not necessarily required.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Although the description uses the term “loudspeaker” other audio transducers are included such as “earphones”.

As such, those skilled in the art will appreciate that the conception, upon which this disclosure is based, may readily be utilized as a basis for the designing of other methods and systems for carrying out the several purposes of the present invention. It is important, therefore, that the claims be regarded as including such equivalent constructions insofar as they do not depart from the spirit and scope of the present invention.

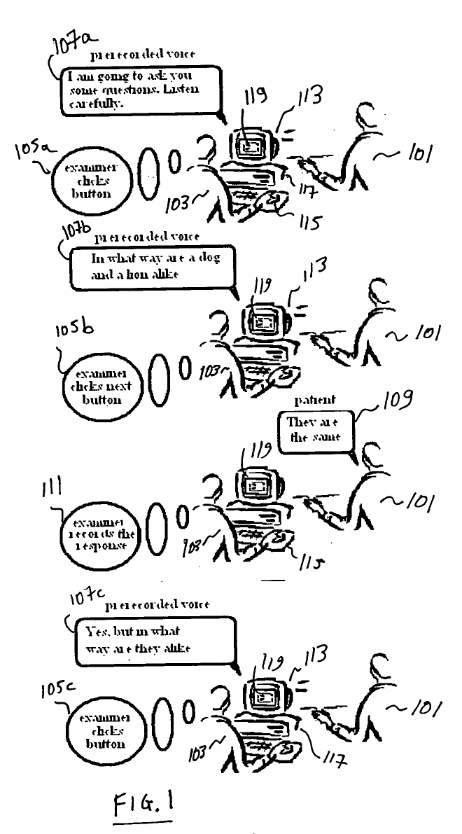

Referring now to the drawings, FIG. 1 illustrates the administration of a psychological examination according to an embodiment of the present invention. FIG. 1 shows an examiner 103 administering a psychological examination to an examinee 101. Examiner 103 sees computer display 119 and examinee 101 does not see computer display 119. Furthermore, examinee 101 does not have access to computer input devices 115, e.g. mouse, keyboard or digital tablet, to insure an ecologically valid examination. The examination process begins in step 105a during which examiner 103 presses a button on a computer input device 115. Pressing of a button (step 105a), using a computer program previously installed and run on computer 117, initiates a software process causing a first instruction 107a, a previously recorded voice, to be audibly played from loudspeaker 113 and heard by examinee 101. In the example of FIG. 1, first instruction 107a, “I am going to ask you some questions. Listen carefully” is heard by examinee 101 from loudspeaker 113. Preferably, first instruction 107a is simultaneously displayed on computer display 119. Examiner 103 has an option to read out loud instruction 107a from computer display 119 instead of initiating a software process audibly playing first instruction 107a. In either case, examiner 103 notes that examinee 101 has understood first instruction 107a, and examiner 103 proceeds to the next step by again pressing a button (step 105b) on computer input device 115, (e.g. mouse, initiating a software process causing a second instruction 107b, a previously recorded voice, to be audibly played from loudspeaker 113. In the example of FIG. 1, second instruction 107b is a question; “In what way are a dog and a lion alike?” Alternatively, examiner 103 reads out loud second instruction 107b as displayed on computer display 119. Examinee 101 responds orally (step 109) to the question asked in instruction 107b. Examiner 103 records the response (step 111) of examinee 101, preferably using a computer input device 115, e.g. keyboard, and stores response information in memory of computer 117. Examiner 103 then proceeds to the next step, preferably by again pressing a button (step 105c) on computer input device 115, initiating a software process causing a third instruction 107c, a previously recorded voice, to be audibly played from loudspeaker 113.

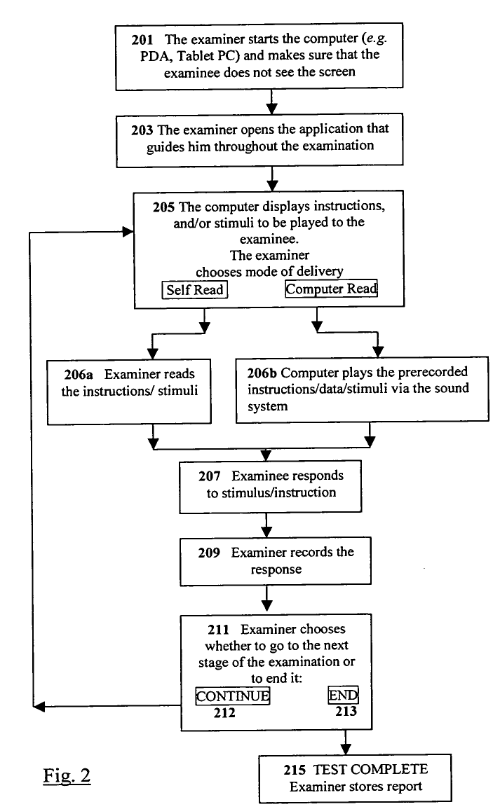

FIG. 2 is a flow chart according to an embodiment of the present invention. Examiner 103 starts computer 117 loads (step 201) into memory of computer 117 a test application and starts the application (step 203) that guides examiner 103 throughout the examination. When examinee 101 is ready, examiner 103 presses a button on computer input device 115 connected to computer 117. Computer 117 displays (step 205) instructions and/or stimuli solely to examiner 103. Examiner chooses either to read out loud (step 206a) the stimuli or instructions as shown on computer display 119 or computer 117 with a sound system audibly plays (step 206b) previously recorded instructions or stimuli. Examinee 101 responds (step 207) for example, orally, by drawing, or by moving hands. The responses of examinee 101 are recorded (step 209) by examiner 103, preferably using computer input device 115. If the examination is unfinished (decision block 211) then examiner 103 presses (step 212) a button and moves on to the next part of the examination. If the examination is ended, (decision block 211) examiner 103 presses (step 213) a button indicating “End of test” and subsequently examiner 103 has the option to store (step 215) or otherwise print a report.

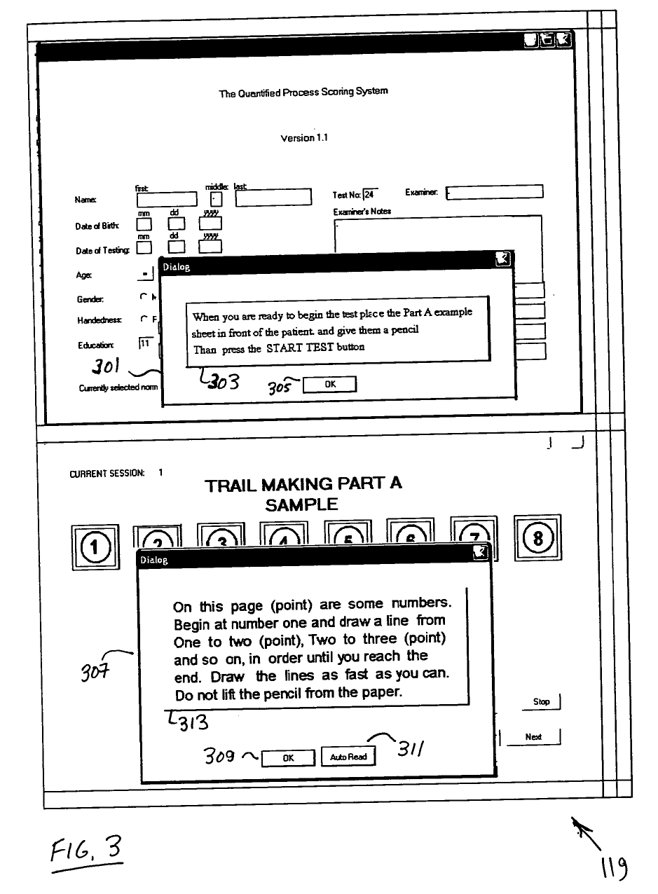

FIG. 3 shows display screens of a computer as viewed by examiner 103 in the course of administering another examination according to an embodiment of the present invention. A dialog box 301 is presented to examiner 103 including an instruction 303 to examiner 103. When examiner 103 has performed the requirements of instruction 303, he/she presses “OK” (step 305). A second dialog box appears before examiner 103 containing an instruction 313 intended for examinee 101. The examiner 103 may choose to read instruction 313 conventionally to examinee 101 and subsequently press an “OK” button 309. Preferably, examiner 103 presses (step 203) “AutoRead” button 311, according to an embodiment of the present invention, and a software process begins causing instruction 313 to be played to examinee 101 from the computer loudspeaker 113. At this point, examiner 103 optionally records responses of examinee 101 using a computer input device 115. In an alternative embodiment of the present invention, step 203 initiates an alternative software process, previously configured, causing instruction 313 to be audibly played to examinee 101 in a language, e.g. his/her mother tongue, other than a language in which examiner 103 is fluent.

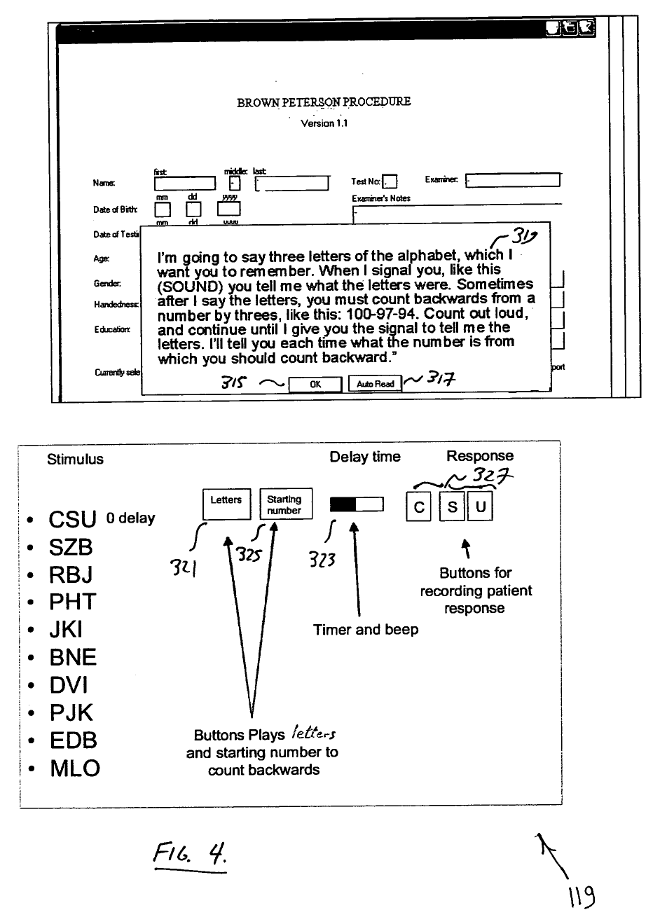

FIG. 4 shows display screens of a computer as viewed by examiner 103 during an examination, according to an embodiment of the present invention. In the example of FIG. 4, instructions and stimuli are presented to examinee 101 using a computer sound system. Preferably, examiner presses (step 203) a “AutoRead” button 317, causing an instruction 319 to be audibly played from computer loudspeaker 113, as follows; “I'm going to say three letters of the alphabet, which I want you to remember. When I signal you like this:”. At this point in time, a prerecorded sound is played to examinee 101 from loudspeaker 113, as an example of an auditory stimulus to be used in the course of the examination. Instruction 319 continues:
. . . you tell me what the letters were. Sometimes after I say the letters, you must count backwards from a number by threes, like this: 100-97-94. Count out loud, and continue until I give you the signal to tell me the letters. I'll tell you each time what the number is from which you should count backward.

According to an embodiment of the present invention, examiner 103 presses (step 203) button 321 labeled “Letters”, starting a software process causing the names of letters for example, C, S, U to be audibly played from computer loudspeaker. A timer/sound button 323 is used by examiner 103 to signal examinee 101 to repeat the names of the three letters, C,S,U; and also start a software timer. Buttons 327 are used by examiner 103 to record the responses of examinee 101. A button 324 labeled “Starting Number” prompts the computer to audibly play to examinee 101 using loudspeaker 113, a starting number for counting backwards.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

1. A method of administering ecologically valid psychological examinations to an examinee by an examiner equipped with a computer, the method comprising the steps of:
(a) visually presenting at least one stimulus or at least one instruction to the examiner on a display operationally connected to the computer; and
(b) performing an action by the examiner selected from the group of actions consisting of:
(i) reading out loud said at least one stimulus or said at least one instruction; and
(ii) pressing an input device operationally connected to the computer thereby audibly playing said at least one stimulus or said at least one instruction to the examinee over a sound system operationally connected to the computer.

2. The method, according to claim 1, wherein solely the examiner interacts with the computer and sees said display.

3. The method, according to claim 1, wherein said sound system includes a sound transducer selected from the group consisting of an earphone and a loudspeaker.

4. The method, according to claim 1, further comprising the steps of:
(c) responding by the examinee to said at least one stimulus or said at least one instruction with at least one physically manifested response; and
(d) recording by the examiner of said at least one response.

5. The method, according to claim 4, wherein said recording is performed by pressing at least one record button operationally connected to an input device of the computer, thereby storing at least one record in computer memory.

6. The method, according to claim 4, further comprising the steps of
(e) ending the psychological examination by the examiner by pressing an end button operationally connected to an input device of the computer; and
(f) storing said at least one record on a storage device operationally connected to the computer by pressing a store report button operationally connected to an input device of the computer.

7. A method of administering ecologically valid psychological examinations to an examinee, the method comprising the steps of:
(a) providing a computer operated solely by an examiner;
(b) visually presenting at least one stimulus or at least one instruction to the examiner on a display operationally connected to said computer; and
(c) performing an action by said examiner selected from the group of actions consisting of:
(i) reading out loud said at least one stimulus or said at least one instruction; and
(ii) pressing an input device operationally connected to said computer thereby audibly playing said at least one stimulus or said at least one instruction to the examinee over a sound system operationally connected to said computer.

8. The method, according to claim 7, wherein said computer is selected from the group consisting of a desktop computer, a portable computer, a notebook computer, a personal digital assistant and a handheld computer.
